(19) United States
(12) Patent Application Publication
(10) Pub. No.: US 2015/0193783 A1
(43) Pub. Date: Jul. 9, 2015

(54) Assessing Client Impact

(71) Applicant: Bank of America Corporation, Charlotte, NC (US)

(72) Inventors: Andrew J. Dawe, Portland, OR (US); Ward B. Simons, Richmond, VA (US); Donald J. Richardson, Concord, NC (US); Christopher J. Fiore, Southington, CT (US); Melissa Ortiz-Munoz, Springfield, VA (US); Allen J. Thompson, Norwell, MA (US)

(73) Assignee: Bank of America Corporation, Charlotte, NC (US)

(21) Appl. No.: 14/149,240

(22) Filed: Jan. 7, 2014

(51) Int. Cl. G06Q 30/02

(52) U.S. Cl. CPC G06Q 30/0201

(57) ABSTRACT

Methods and systems for assessing client impact are presented. In particular, some aspects of the disclosure provide ways of assessing the effects of various projects and deployments on different clients of an organization. In some embodiments, a computer system may gather project data associated with one or more projects. Subsequently, the computer system may identify one or more client impacts based on the gathered project data. The computer system then may publish an inventory based on the one or more identified client impacts. In some instances, in publishing the inventory, the computer system may analyze a volume of change activity for at least one client, and may determine, based on this analysis, that at least one deployment event of at least one project should be delayed for the at least one client.

BACKGROUND

Aspects of the disclosure relate to computer hardware and software. In particular, one or more aspects of the disclosure generally relate to computer hardware and software for assessing client impact.

Large organizations, such as financial institutions, may have many clients, and in serving these clients, such organizations may undertake many projects that affect different clients in different ways. For example, a financial institution may include a commercial banking line of business, and various initiatives and other projects undertaken by this line of business may affect commercial banking clients of the organization in different ways.

Although an organization and its various client-service teams may have a relatively good understanding of what projects are being undertaken, as well as an understanding of how specific projects may affect specific clients, it may be difficult to gain an understanding of how a specific client may be holistically impacted by an entire portfolio of projects that may be undertaken by an organization and/or by a specific line of business within an organization.

### SUMMARY

Aspects of the disclosure relate to various systems and techniques that provide effective, efficient, scalable, and convenient ways of assessing client impact, particularly in ways that may enable an organization to understand how specific clients may be holistically impacted by an entire portfolio of projects being undertaken by the organization.

In some arrangements discussed in greater detail below, a computer-implemented process may provide ways of identifying what projects are occurring within an organization and/or within a specific line of business of an organization. Of those projects that may be occurring, it may, for instance, be determined which projects are going to impact a client in a meaningful way. In addition, an inventory may be created and/or published to provide a holistic view of how specific clients are impacted by an entire portfolio of projects (which may, e.g., be undertaken by the organization and/or by a specific line of business within the organization), and the inventory may also allow individuals to drill-down to access specific information about the effects of specific projects and specific deployment events on particular clients. By leveraging various aspects of the disclosure, an organization and its employees may be able to better serve the organization's clients, as the organization and its employees may have a better understanding of the overall impact that all of the projects being undertaken by the organization and/or by a specific line of business within the organization may have on a specific client.

Thus, in some embodiments discussed in greater detail below, a computer system may gather project data associated with one or more projects. Subsequently, the computer system may identify one or more client impacts based on the gathered project data. The computer system then may publish an inventory based on the one or more identified client impacts.

In some instances, gathering the project data may include automatically collecting at least a portion of the project data from one or more project management systems. Additionally or alternatively, gathering the project data may include receiving at least a portion of the project data as user input. In some instances, the gathered project data may represent a complete project portfolio for at least one line of business of a financial institution.

In some instances, in identifying the one or more client impacts, the computer system may determine, for each project of the one or more projects, whether one or more client impacts exist for the corresponding project. Based on determining that a set of client impacts exists for the one or more projects, the computer system may categorize each client impact of the set of client impacts. Additionally or alternatively, in identifying the one or more client impacts, the computer system may determine whether one or more client impacts exist for one or more deployment events associated with at least one project.

In some instances, in identifying the one or more client impacts, the computer system may produce an impacted clients list. In addition, the computer system may contribute the impacted clients list to the inventory.

In some instances, in publishing the inventory, the computer system may provide client-specific change information to one or more coverage personnel. Additionally or alternatively, in publishing the inventory, the computer system may analyze a volume of change activity for at least one client, and may determine, based on this analysis, that at least one deployment event of at least one project should be delayed for the at least one client.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A illustrates an example operating environment in which various aspects of the disclosure may be implemented;

FIG. 1B illustrates another example operating environment in which various aspects of the disclosure may be implemented;

FIG. 2 illustrates an example of a system for assessing client impact according to one or more aspects of the disclosure;

FIG. 3 illustrates a flowchart that depicts a method of assessing client impact according to one or more aspects of the disclosure; and

FIGS. 4-14 illustrate examples of user interfaces that may be provided by a computer system in assessing client impact according to one or more aspects of the disclosure.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

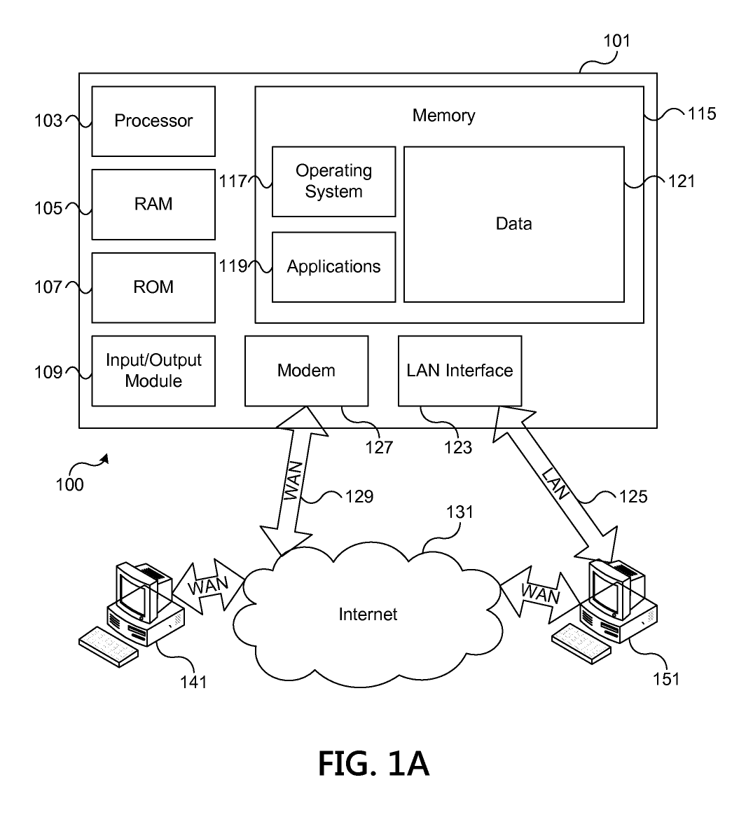

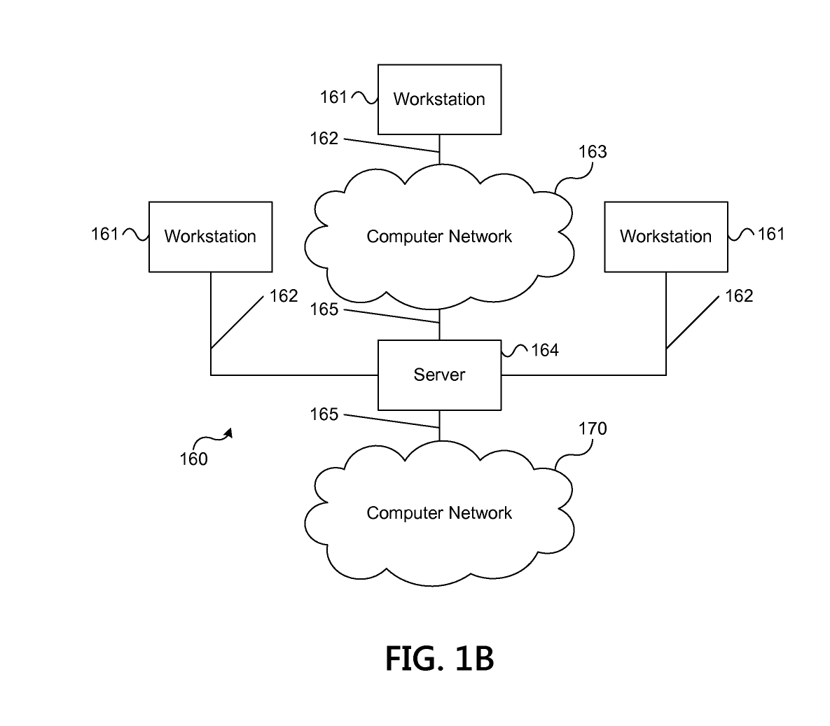

As noted above, certain embodiments are discussed herein that relate to assessing client impact. Before discussing these concepts in greater detail, however, an example of a computing device that can be used in implementing various aspects of the disclosure, as well as an example of an operating environment in which various embodiments can be implemented, will first be described with respect to FIGS. 1A and 1B.

FIG. 1A illustrates an example block diagram of a generic computing device 101 (e.g., a computer server) in an example computing environment 100 that may be used according to one or more illustrative embodiments of the disclosure. The generic computing device 101 may have a processor 103 for controlling overall operation of the server and its associated components, including random access memory (RAM) 105, read-only memory (ROM) 107, input/output (I/O) module 109, and memory 115.

I/O module 109 may include a microphone, mouse, keypad, touch screen, scanner, optical reader, and/or stylus (or other input device(s)) through which a user of generic computing device 101 may provide input, and may also include one or more of a speaker for providing audio output and a video display device for providing textual, audiovisual, and/or graphical output. Software may be stored within memory 115 and/or other storage to provide instructions to processor 103 for enabling generic computing device 101 to perform various functions. For example, memory 115 may store software used by the generic computing device 101, such as an operating system 117, application programs 119, and an associated database 121. Alternatively, some or all of the computer executable instructions for generic computing device 101 may be embodied in hardware or firmware (not shown).

The generic computing device 101 may operate in a networked environment supporting connections to one or more remote computers, such as terminals 141 and 151. The terminals 141 and 151 may be personal computers or servers that include many or all of the elements described above with respect to the generic computing device 101. The network connections depicted in FIG. 1A include a local area network (LAN) 125 and a wide area network (WAN) 129, but may also include other networks. When used in a LAN networking environment, the generic computing device 101 may be connected to the LAN 125 through a network interface or adapter 123. When used in a WAN networking environment, the generic computing device 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 101 and/or terminals 141 or 151 may also be mobile terminals (e.g., mobile phones, smartphones, PDAs, notebooks, and so on) including various other components, such as a battery, speaker, and antennas (not shown).

The disclosure is operational with numerous other general purpose or special purpose computing system environments or configurations. Examples of well-known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 1B illustrates another example operating environment in which various aspects of the disclosure may be implemented. As illustrated, system 160 may include one or more workstations 161. Workstations 161 may, in some examples, be connected by one or more communications links 162 to computer network 163 that may be linked via communications links 165 to server 164. In system 160, server 164 may be any suitable server, processor, computer, or data processing device, or combination of the same. Server 164 may be used to process the instructions received from, and the transactions entered into by, one or more participants.

According to one or more aspects, system 160 may be associated with a financial institution, such as a bank. Various elements may be located within the financial institution and/or may be located remotely from the financial institution. For instance, one or more workstations 161 may be located within a branch office of a financial institution. Such workstations may be used, for example, by customer service representatives, other employees, and/or customers of the financial institution in conducting financial transactions via network 163. Additionally or alternatively, one or more workstations 161 may be located at a user location (e.g., a customer's home or office). Such workstations also may be used, for example, by customers of the financial institution in conducting financial transactions via computer network 163 or computer network 170.

Computer network 163 and computer network 170 may be any suitable computer networks including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communications links 162 and 165 may be any communications links suitable for communicating between workstations 161 and server 164, such as network links, dial-up links, wireless links, hard-wired links, and/or the like.

Having described an example of a computing device that can be used in implementing various aspects of the disclosure and an operating environment in which various aspects of the disclosure can be implemented, several embodiments will now be discussed in greater detail. As introduced above, some aspects of the disclosure generally relate to assessing client impact, particularly the impact or impacts of various projects and deployments on different clients of an organization, such as a financial institution. In the discussion below, various examples illustrating how client impacts can be identified, evaluated, and/or otherwise assessed in accordance with one or more embodiments will be provided.

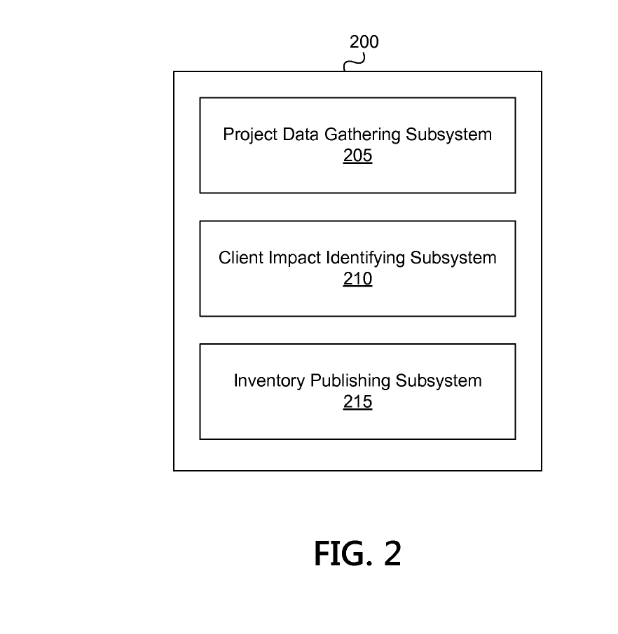

FIG. 2 illustrates an example of a system 200 for assessing client impact according to one or more embodiments. In some embodiments, system 200 may be implemented in one or more computing devices, which may include and/or incorporate one or more processors, one or more memories, and/or one or more aspects of the computing device 101 discussed above. In some instances, system 200 may include a number of different subsystems and/or databases. In some arrangements, all of the subsystems included in system 200 may be included in and/or incorporated into a single computing device, while in other arrangements, each subsystem included in system 200 (and/or combinations thereof) may be included in and/or incorporated into a distinct and/or dedicated computing device. In addition, each of the databases included in system 200 may be included in and/or incorporated into the same computing device as one or more other subsystems of system 200, or, in other arrangements, may be included in and/or incorporated into distinct and/or dedicated computing devices (which, e.g., are communicatively coupled to and/or otherwise accessible to system 200 and/or its various subsystems).

As seen in FIG. 2, in some embodiments, system 200 may include a project data gathering subsystem 205, a client impact identifying subsystem 210, and an inventory publishing subsystem 215. This arrangement represents one example configuration of system 200. In other embodiments, one or more elements of system 200 may be combined and/or additional and/or alternative subsystems may be included in addition to and/or instead of those shown in FIG. 2.

In some embodiments, project data gathering subsystem 205 may be configured to collect project data from one or more project management systems and/or process feeds and/or otherwise capture data from one or more change management systems. In addition, project data gathering subsystem 205 may be configured to receive project data as user input for specific initiatives and/or other projects.

In some embodiments, client impact identifying subsystem 210 may be configured to determine whether a particular project has a client impact and/or whether a particular deployment event associated with a particular project has a client impact. In addition, client impact identifying subsystem 210 may be configured to categorize identified client impacts, and may be further configured to produce an impacted clients list and contribute the list to an inventory.

In some embodiments, inventory publishing subsystem 215 may be configured to provide client-specific change information to coverage personnel (e.g., by making available an impacted clients list received from subsystem 210). In addition, inventory publishing subsystem 215 may be configured to analyze change activity for specific clients and determine whether specific projects and/or deployment events should be staggered and/or otherwise delayed (e.g., so as not to overwhelm one or more specific clients with a relatively large amount of change).

As indicated above, these are examples of the subsystems, databases, and/or other elements that may be included in system 200 in some embodiments, as well as some of the functions that may be performed (e.g., by system 200 and its various subsystems). In other embodiments, additional and/or alternative subsystems, databases, and/or other elements may similarly be included, and/or other functions may be performed, in addition to and/or instead of those discussed above.

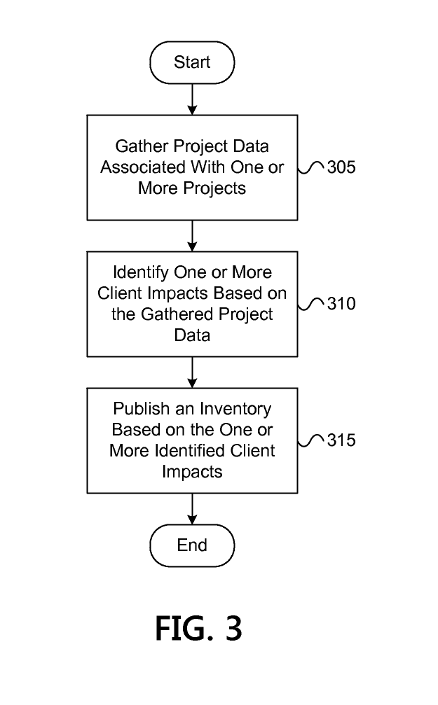

Having described an example system that may be used in assessing client impact in some embodiments, an example of a method that may, in some embodiments, be performed (e.g., by such a system 200; by another computing device, such as computing device 101; and/or the like) will now be discussed in greater detail with respect to FIG. 3.

FIG. 3 illustrates a flowchart that depicts a method of assessing client impact according to one or more aspects of the disclosure. In some embodiments, the example method illustrated in FIG. 3 may be performed by a computing device, which may include and/or implement one or more aspects of computing device 101. In additional and/or alternative embodiments, the example method illustrated in FIG. 3 may be performed by a computer system, such as a server computer system that is owned, operated, and/or controlled by a financial institution (which may, e.g., maintain the computer system in a back office or data center to assess client impact), and such a computer system may include one or more computing devices that include and/or implement one or more aspects of computing device 101 and/or system 200. In other embodiments, the example method illustrated in FIG. 3 may be implemented in and/or may otherwise be embodied in computer-readable instructions that may be stored in a computer-readable medium, such as a memory.

As seen in FIG. 3, the method may be initiated in step 305, in which project data associated with one or more projects may be gathered. For example, in step 305, a computing device (e.g., computing device 101, system 200, and/or the like) may gather project data associated with one or more projects. In one or more arrangements, the project data may, for instance, include information identifying specific changes that are being made (and/or have been made and/or are to be made) to specific products and/or services that are offered and/or provided by an organization (e.g., the organization that may be using the computing device to execute the method illustrated in FIG. 3). In some instances, the project data may include information about specific deployment events of particular projects. For example, each project may have one or more deployment events, and each deployment event may be an instance in which one or more specific changes (e.g., in products, services, and/or the like) are rolled out and/or otherwise provided to one or more clients in connection with a corresponding project.

In some instances, gathering the project data may include automatically collecting at least a portion of the project data from one or more project management systems. For example, in gathering the project data in step 305, the computing device may collect information about various projects from one or more project management systems (which may, e.g., be owned, operated, and/or maintained by specific project teams and/or other groups or individuals within the organization). In collecting such information, the computing device may, for instance, automatically capture information about new projects and/or changes in existing projects from one or more data feeds that may be provided by one or more change management systems (which may, e.g., be updated by one or more individuals who may be involved in various projects, such as a project manager, change manager, and/or the like).

In some instances, gathering the project data may include receiving at least a portion of the project data as user input. For example, in gathering the project data in step 305, the computing device may receive at least a portion of the project data as user input (which may, e.g., be manually entered by a user of the computing device) for certain initiatives and/or other projects. This may, for example, allow the computing device to better capture information for all of the projects that may be on-going in an organization and/or in a specific line of business of an organization, as in some instances, the project data that may be automatically gathered in step 305 might not include, for various reasons, information for certain projects.

In one or more arrangements, the gathered project data may represent a complete project portfolio for at least one line of business of a financial institution. For example, in some arrangements, the project data gathered in step 305 may represent a current view of the entire project portfolio of a commercial banking line of business of a financial institution. In other instances, the project data gathered in step 305 may represent a current view of the entire project portfolio for an enterprise (which, e.g., might not be a financial institution) or a specific line of business within such an enterprise.

Continuing to refer to FIG. 3, in step 310, one or more client impacts may be identified based on the gathered project data. For example, in step 310, the computing device may identify one or more client impacts based on the project data gathered in step 305. In one or more arrangements, a “client impact” may be a significant and/or relatively meaningful effect on a specific client and/or the client's relationship with the organization (e.g., the organization that may be using the computing device to execute the method illustrated in FIG. 3) as a result of a specific project and/or deployment event. For example, a client impact may include a specific effect on a specific client that is caused by one or more changes made by the organization in completing a particular project or deployment event.

In some instances, identifying the one or more client impacts may include determining, for each project of the one or more projects, whether one or more client impacts exist for the corresponding project, and based on determining that a set of client impacts exists for the one or more projects, categorizing each client impact of the set of client impacts. For example, in identifying one or more client impacts in step 310, the computing device may evaluate each project of the one or more projects to determine whether one or more client impacts exist. In addition, based on determining that one or more clients impacts do exist (which, e.g., the computing device may group into a set of client impacts), the computing device may categorize each client impact included in the set of client impacts (which may, e.g., include the client impacts determined to exist based on the evaluation of each of the projects). In some instances, in determining whether one or more client impacts exist for a specific project, the computing device may automatically determine whether such client impacts exist. For example, in determining whether one or more client impacts exist for a specific project, the computing device may parse the gathered project data associated with the project to identify and/or categorize changes being made to specific products and/or services that are offered and/or provided to specific clients. Additionally or alternatively, in determining whether one or more client impacts exist for a specific project, the computing device may receive assessment data as user input from one or more users (who may, e.g., manually identify, categorize, and/or otherwise assess changes being made to specific products and/or services that are offered and/or provided to specific clients).

In categorizing client impacts (which may, e.g., be identified and/or determined to exist in step 310), the computing device may determine that each of the identified client impacts corresponds to one or more predefined categories of client impacts, as these categories may assist the organization in better understanding the nature of the change(s) being made and how certain clients will be affected. For example, the predefined categories may include an “awareness/instructions” impact category, which may correspond to relatively basic changes where no significant actions are needed from a client, but the client will nevertheless be notified of the changes. The predefined categories also may include a “client action required” impact category, which may correspond to changes that might require a client to spend a significant amount of time preparing for the change (e.g., significant changes to user interfaces, security protocols, the training that might be required, and the like). The predefined categories also may include a “fees/pricing” impact category, which may correspond to changes in pricing, billing methodology, and/or terms and conditions. The predefined categories also may include a “location change” impact category, which may correspond to banking center closings and divestitures, vault and item processing site changes, and/or other location changes. The predefined categories also may include one or more categories for changes that do not have any client impact, such as a “new product/features” category, which may correspond to changes that may only affect a client if the client signs up for new services or opens new accounts, as well as a “none” category, which may correspond to changes where a client will not notice or experience any differences after deployment of the change.

In some instances, identifying the one or more client impacts may include determining whether one or more client impacts exist for one or more deployment events associated with at least one project. For example, in identifying the one or more client impacts in step 310, the computing device may determine whether one or more client impacts exist for one or more deployment events included in the one or more projects that are described and/or otherwise included in the gathered project data and/or that are being evaluated by the computing device. In particular, the project data may include information about specific deployment events of particular projects, and each project may have one or more deployment events. In one or more arrangements, each deployment event may be an instance in which one or more specific changes (e.g., in products, services, and/or the like) are rolled out and/or otherwise provided to one or more clients in connection with a corresponding project. Thus, in identifying the one or more client impacts in step 310, the computing device may analyze any and/or all of such deployment events to determine whether specific deployment events have had and/or will have client impact. The impact(s) caused by specific deployment events may, in some instances, subsequently be categorized in the manner discussed above.

In some instances, identifying the one or more client impacts may include producing an impacted clients list, and contributing the impacted clients list to an inventory. For example, in identifying one or more client impacts in step 310, the computing device may produce an impacted clients list, and subsequently may contribute the impacted clients list to an inventory (which may, e.g., be published by the computing device, as discussed in greater detail below). In some instances, the impacted clients list may, for instance, identify one or more specific clients that may experience one or more client impacts as a result of the projects and/or deployment events being evaluated by the computing device. In addition, the impacted clients list may, for example, include additional information about the specific client impacts that may be experienced by specific clients, such as information about the category or categories of the client impacts, information about the specific projects that may impact specific clients (e.g., information identifying specific changes that will impact specific clients), and/or the like. In some instances, the impacted clients list may additionally or alternatively include information about the impact(s) of particular changes on a family or parent company or other entity, as well as information about the specific impact(s) on associated primary or child companies or other subsidiary entities. Further, in contributing the impacted clients list to an inventory, the computing device may, for instance, upload and/or otherwise make available the impacted clients to a database and/or other resources for publication.

Continuing to refer to FIG. 3, in step 315, an inventory may be published based on the one or more identified client impacts. For example, in step 315, the computing device may publish an inventory based on the one or more client impacts identified in step 310. In one or more arrangements, the inventory may identify specific clients being impacted by various changes associated with various projects and/or deployment events. Additionally or alternatively, the inventory may identify an overall level of change being imposed on each client (e.g., both at a parent/family level and at a child/primary level) as a result of various projects and/or deployment events (which may, e.g., be included in portfolio of projects being undertaken by the organization and/or by a line of business of the organization, as may be reflected in the project data gathered in step 305).

In some instances, publishing the inventory may include providing client-specific change information to one or more coverage personnel. For example, in publishing the inventory in step 315, the computing device may provide client-specific change information to one or more coverage personnel. The client-specific change information may, for instance, identify the various changes and/or client impacts that may affect a particular client (e.g., based on the client impacts identified in step 310). In addition, the one or more coverage personnel who receive the change information for a particular client may be selected to receive such information by the computing device based on their relationship with the particular client (e.g., such as individuals who may have a sales relationship with the client, a service relationship with the client, and/or the like). By providing such client-specific change information to one or more coverage personnel for a particular client, the computing device may enable such coverage personnel to have a holistic discussion with the client about the changes that have been and/or are being rolled out to them.

In some instances, publishing the inventory may include analyzing a volume of change activity for at least one client, and based on the analyzing, determining that at least one deployment event of at least one project should be delayed for the at least one client. For example, in publishing the inventory in step 315, the computing device may analyze a volume of change activity for a particular client (e.g., by calculating, estimating, and/or otherwise determining a numerical and/or qualitative amount of change being imposed on the client as a result of all of the client impacts identified in step 310). Subsequently, the computing device may determine, based on this analysis, whether one or more deployment events of one or more projects should be staggered and/or otherwise delayed (e.g., for all clients, for some clients, only for the specific client, and/or the like). For example, based on the volume of change activity exceeding a predetermined threshold (which may, e.g., be a numerical threshold, such as a specific number on a scale between one and one hundred, or a qualitative threshold, such as an impact level between “no change activity,” “low change activity,” “intermediate change activity,” and “high change activity”), the computing device may determine that one or more specific deployment events of one or more specific projects should be staggered or delayed. On the other hand, based on the volume of change activity being under or at the predetermined threshold, the computing device may determine that one or more deployment events of one or more projects should not be staggered or delayed. By determining to delay certain deployment events in this way, the computing device may enable the organization and/or a line of business within the organization to prevent a relatively large or excessive amount of change from being imposed on a single client at any given time.

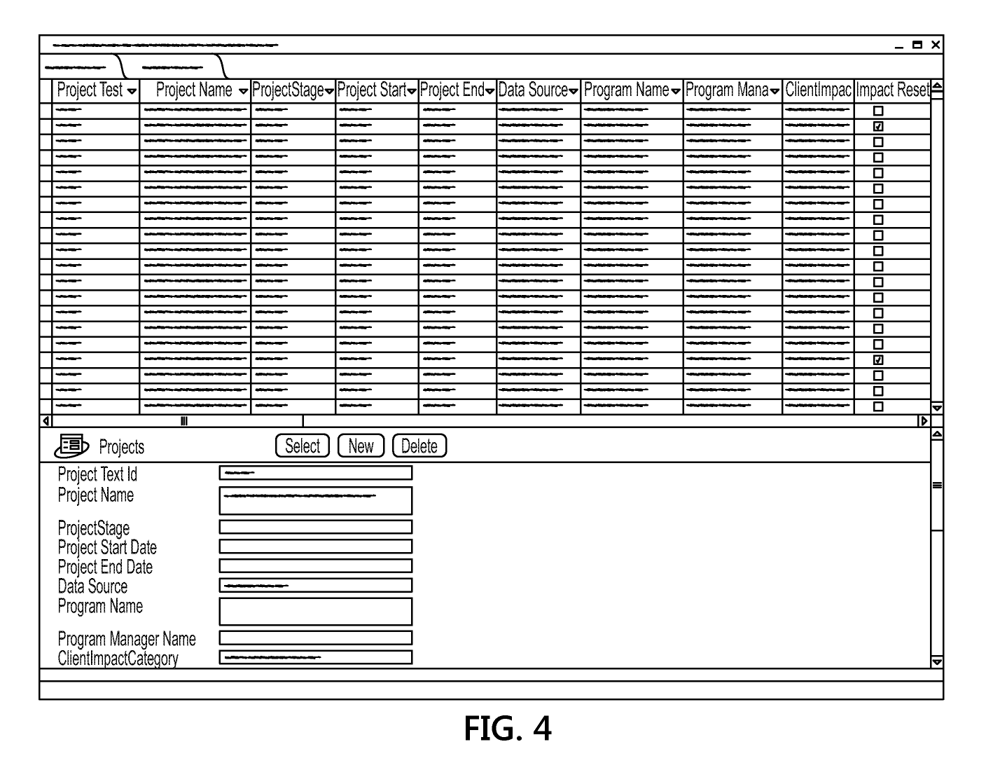

Having described several examples of the processing that may be performed in assessing client impact in some embodiments, several example user interfaces that might be displayed and/or otherwise provided by a computing device, such as a computing device implementing one or more aspects of computing device 101 and/or system 200, in performing such processing and/or in otherwise implementing various aspects of the disclosure will now be discussed with respect to FIGS. 4-14.

FIGS. 4-14 illustrate examples of user interfaces that may be provided by a computer system in assessing client impact according to one or more aspects of the disclosure. In one or more embodiments, a computing device implementing one or more aspects of the disclosure (e.g., computing device 101, system 200, and/or one or more other devices) may display and/or otherwise provide any and/or all of the example user interfaces illustrated in FIGS. 4-14 in providing various features and/or implementing other aspects of the disclosure.

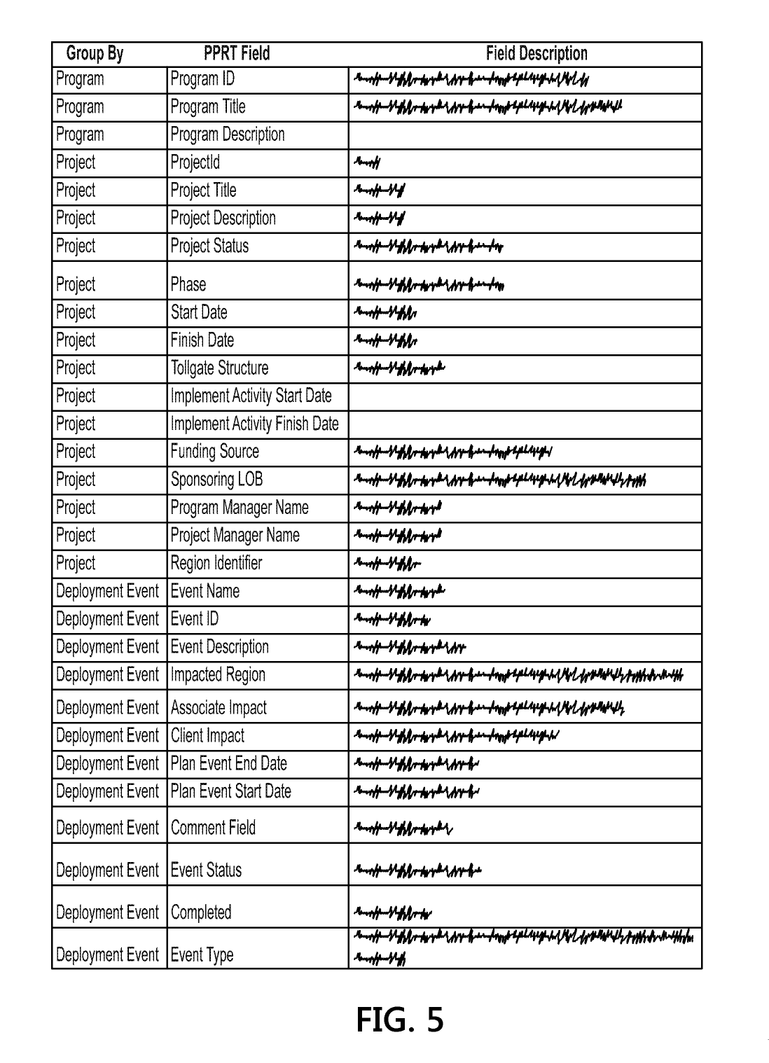

For example, FIG. 4 illustrates an example user interface that is configured to allow a user to search for and/or filter through various projects, create and/or delete information for projects, and/or otherwise select and/or interact with data associated with various projects that may be used by the computing device in assessing client impact. FIG. 5 illustrates an example user interface that is configured to include various types of project data that may be imported into a database that may be used by the computing device in assessing client impact.

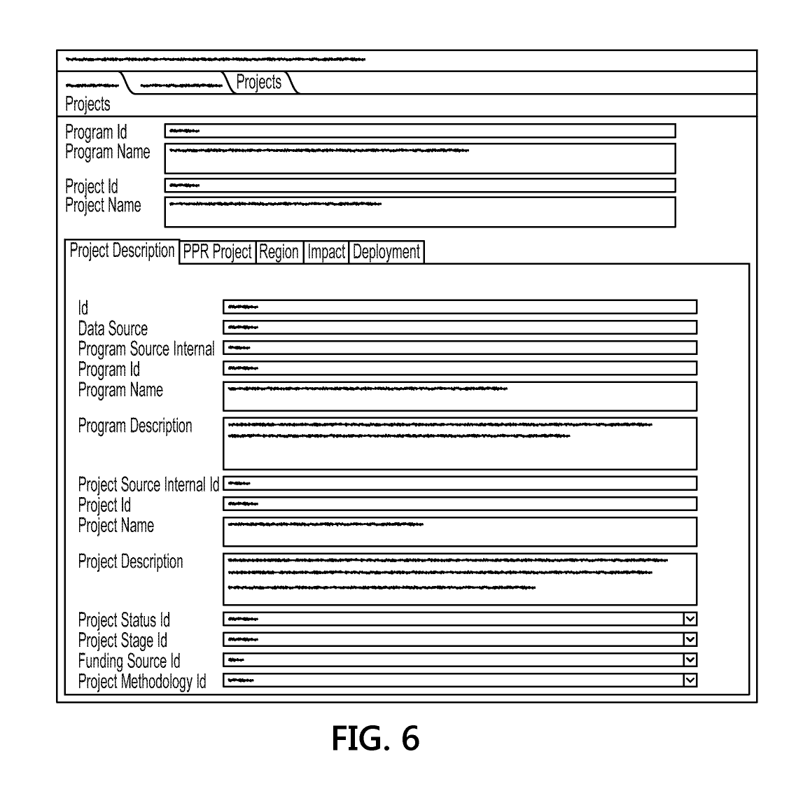

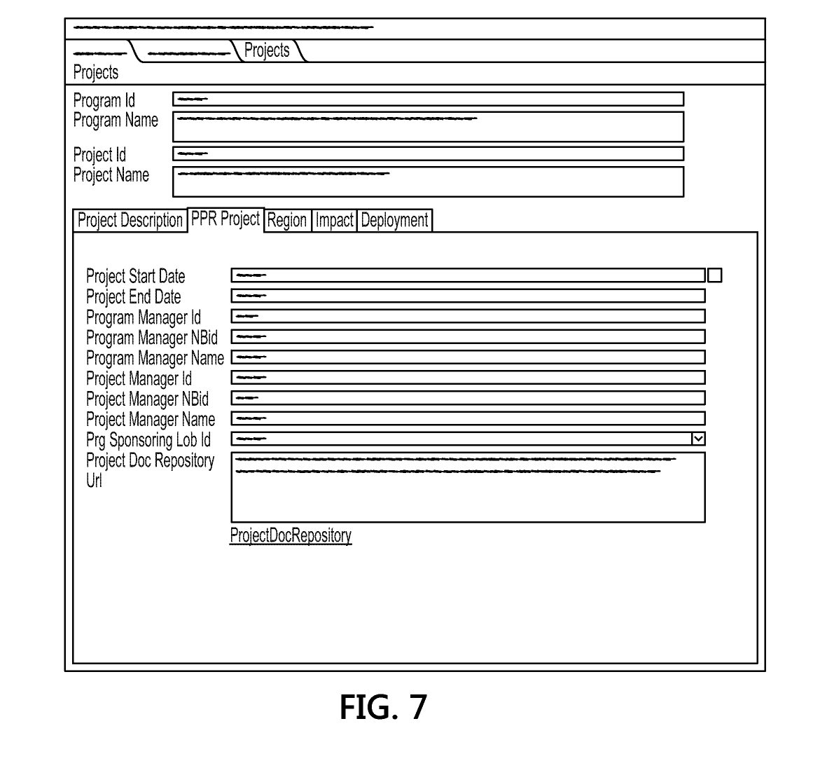

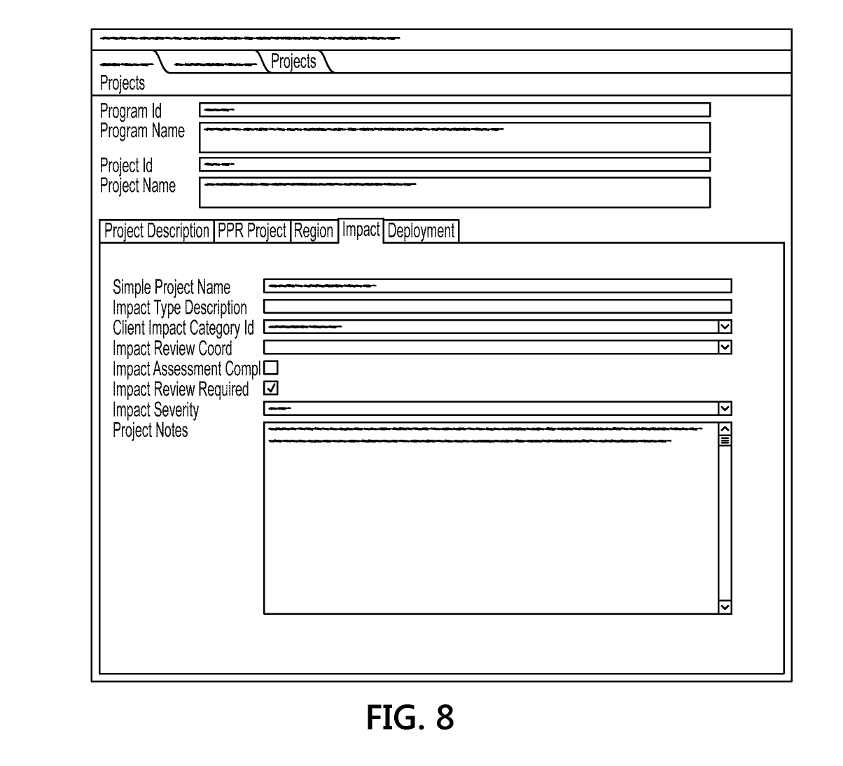

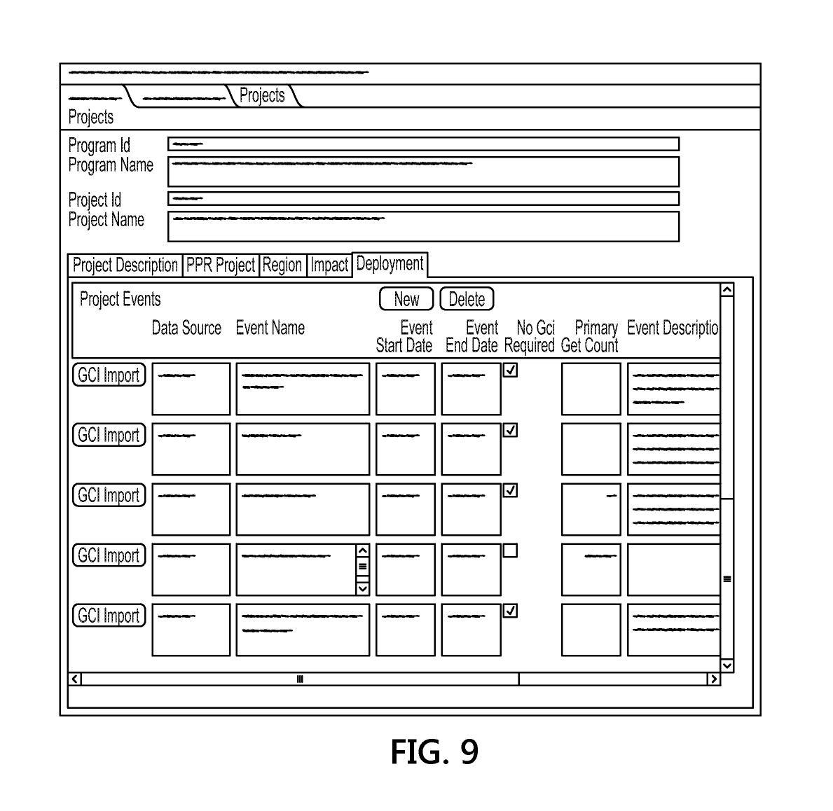

FIG. 6 illustrates an example user interface that is configured to allow a user to view descriptive information about each project that may be included in a database used by the computing device in assessing client impact. FIG. 7 illustrates an example user interface that is configured to allow a user to view additional information (e.g., contact information, links to additional project resources, and/or the like) about each project that may be included in a database used by the computing device in assessing client impact. FIG. 8 illustrates an example user interface that is configured to allow a user to enter and/or modify impact data (such as, e.g., the type and/or severity of various client impacts that may result from various projects and/or deployment events) that may be used by the computing device in assessing client impact. FIG. 9 illustrates an example user interface that is configured to allow a user to view and/or otherwise interact with information about various deployment events of a particular project that may be evaluated by the computing device in assessing client impact.

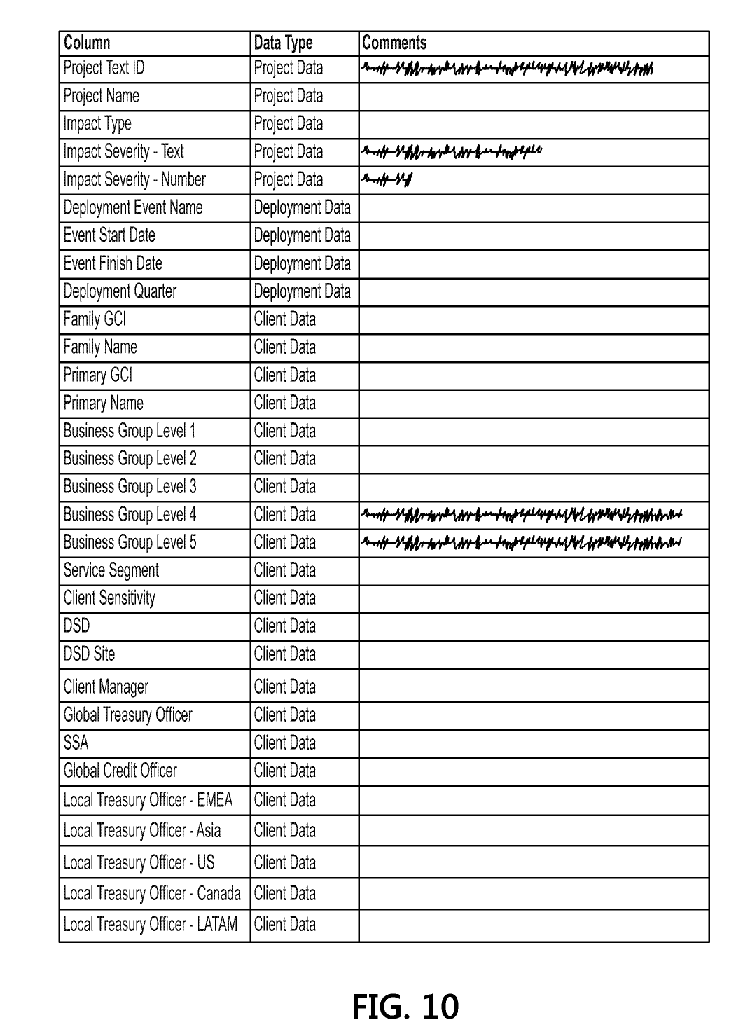

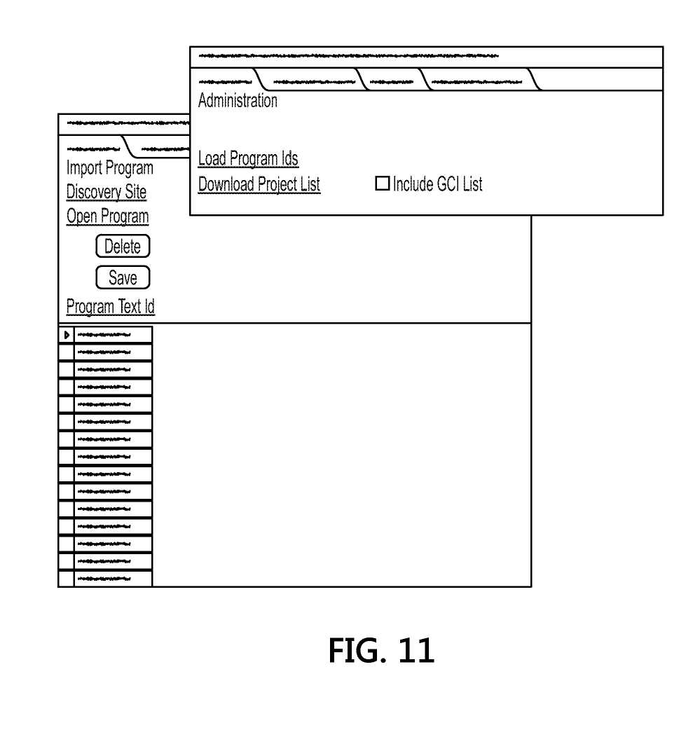

FIG. 10 illustrates an example user interface that is configured to include various types of client data that may be used by the computing device in assessing client impact. FIG. 11 illustrates several example user interfaces that are configured to allow a user to perform administrative functions, such as allowing the user to update and/or otherwise modify which change management systems and/or programs may be used by the computing device in assessing client impact.

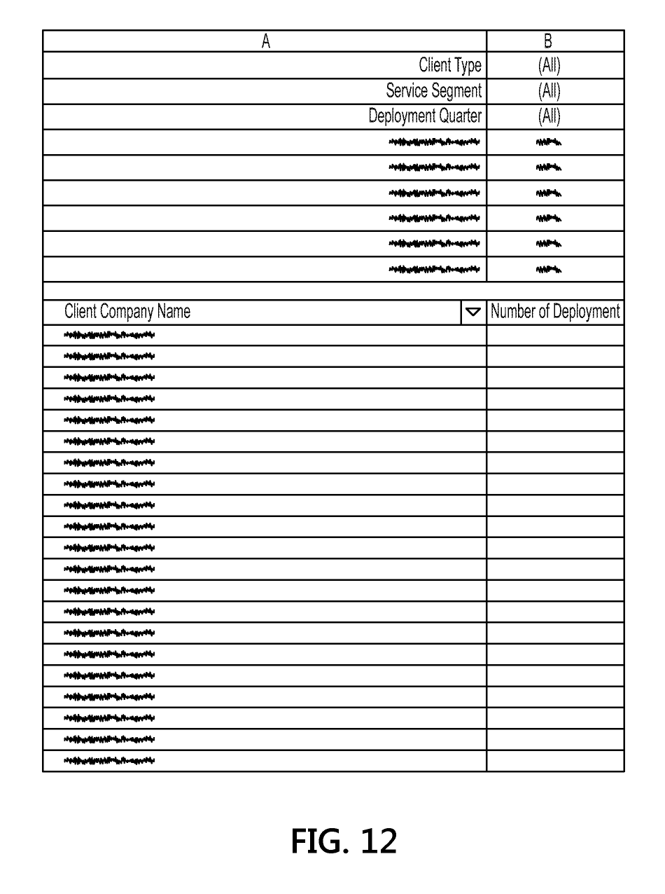

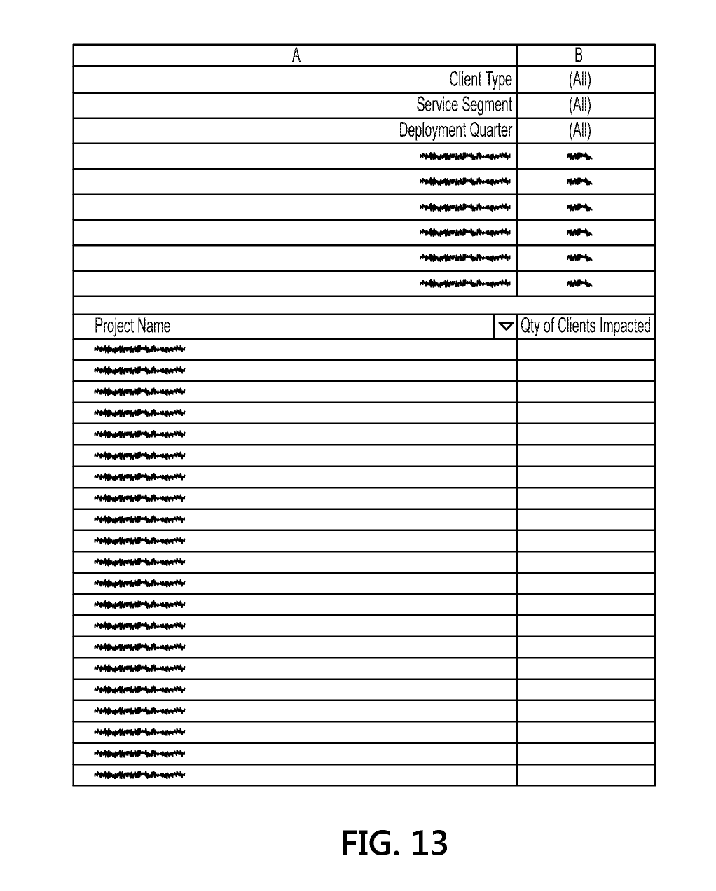

FIGS. 12 and 13 illustrate example user interfaces that are configured to allow a user to look-up information about specific clients and projects, including information about the specific impacts affecting particular clients and/or the client impacts caused by specific projects. In particular, using the example user interfaces illustrated in FIGS. 12 and 13, a user of the computing device may be able to find and view information that is most relevant to his or her role in serving one or more clients of the organization. For example, if the user is in a sales role within the organization and serves a particular set of clients, the user may be able to look up and view client impact information that is relevant only to those clients that he or she serves. In another example, if the user is in a support role within the organization and works on a number of projects that may affect various clients, the user may be able to look up and view client impact information that is relevant only to the projects that he or she is working on.

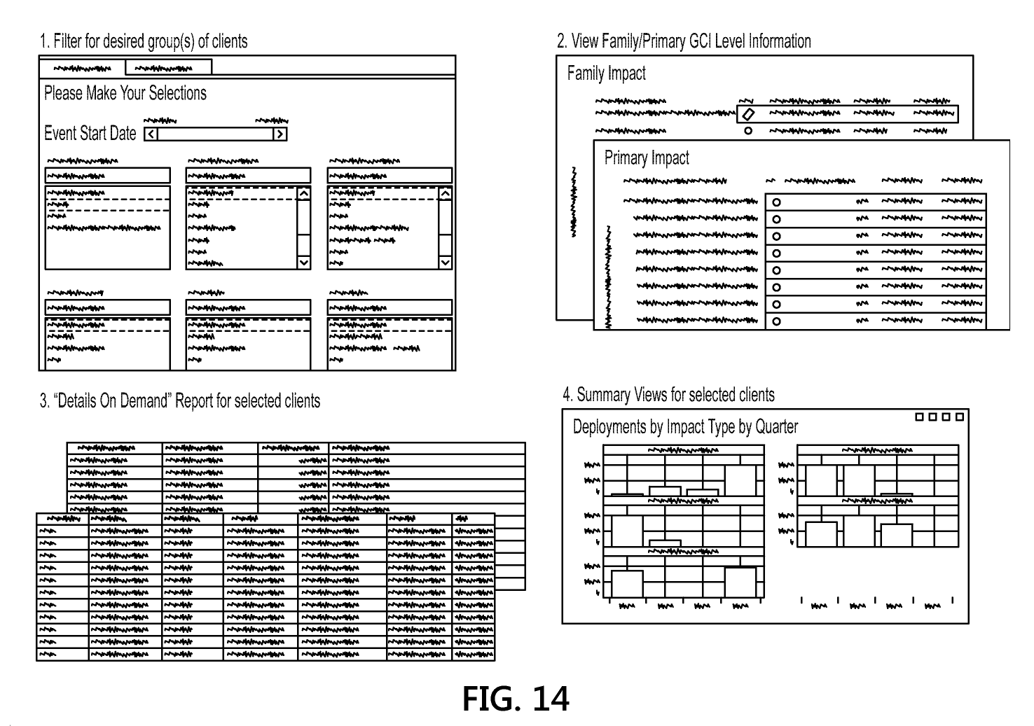

FIG. 14 illustrates several example user interfaces that are configured to allow a user to prepare various reports and/or view other information about specific clients and/or projects. For example, using one or more of the example user interfaces illustrated in FIG. 14, a user of the computing device may be able to generate and/or view detailed and/or summary reports about the projects and/or deployment events that may impact one or more specific clients being served by the particular user.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable memory. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims are included in the scope of the present disclosure. For example, the steps illustrated in the illustrative figures may be performed in other than the recited order, and one or more steps illustrated may be optional in accordance with aspects of the disclosure.

What is claimed is:

1. A method, comprising:
gathering, by a computing device, project data associated with one or more projects;
identifying, by the computing device, one or more client impacts based on the gathered project data; and
publishing, by the computing device, an inventory based on the one or more identified client impacts.

2. The method of claim 1, wherein gathering the project data includes automatically collecting at least a portion of the project data from one or more project management systems.

3. The method of claim 1, wherein gathering the project data includes receiving at least a portion of the project data as user input.

4. The method of claim 1, wherein the gathered project data represents a complete project portfolio for at least one line of business of a financial institution.

5. The method of claim 1, wherein identifying the one or more client impacts includes:
determining, for each project of the one or more projects, whether one or more client impacts exist for the corresponding project; and
based on determining that a set of client impacts exists for the one or more projects, categorizing each client impact of the set of client impacts.

6. The method of claim 1, wherein identifying the one or more client impacts includes determining whether one or more client impacts exist for one or more deployment events associated with at least one project.

7. The method of claim 1, wherein identifying the one or more client impacts includes:
producing an impacted clients list; and
contributing the impacted clients list to the inventory.

8. The method of claim 1, wherein publishing the inventory includes providing client-specific change information to one or more coverage personnel.

9. The method of claim 1, wherein publishing the inventory includes:
analyzing a volume of change activity for at least one client; and
based on the analyzing, determining that at least one deployment event of at least one project should be delayed for the at least one client.

10. A computer system, comprising:
at least one processor; and
memory storing computer-readable instructions that, when executed by the at least one processor, cause the computer system to:
gather project data associated with one or more projects;
identify one or more client impacts based on the gathered project data; and
publish an inventory based on the one or more identified client impacts.

11. The computer system of claim 10, wherein gathering the project data includes automatically collecting at least a portion of the project data from one or more project management systems.

12. The computer system of claim 10, wherein gathering the project data includes receiving at least a portion of the project data as user input.

13. The computer system of claim 10, wherein the gathered project data represents a complete project portfolio for at least one line of business of a financial institution.

14. The computer system of claim 10, wherein identifying the one or more client impacts includes:
determining, for each project of the one or more projects, whether one or more client impacts exist for the corresponding project; and
based on determining that a set of client impacts exists for the one or more projects, categorizing each client impact of the set of client impacts.

15. The computer system of claim 10, wherein identifying the one or more client impacts includes determining whether one or more client impacts exist for one or more deployment events associated with at least one project.

16. The computer system of claim 10, wherein identifying the one or more client impacts includes:
producing an impacted clients list; and
contributing the impacted clients list to the inventory.

17. The computer system of claim 10, wherein publishing the inventory includes providing client-specific change information to one or more coverage personnel.

18. The computer system of claim 10, wherein publishing the inventory includes:
analyzing a volume of change activity for at least one client; and
based on the analyzing, determining that at least one deployment event of at least one project should be delayed for the at least one client.

19. One or more non-transitory computer-readable media storing computer-executable instructions that, when executed, cause at least one computing device to:
gather project data associated with one or more projects;
identify one or more client impacts based on the gathered project data; and
publish an inventory based on the one or more identified client impacts.

20. The one or more non-transitory computer-readable media of claim 19, wherein publishing the inventory includes:
analyzing a volume of change activity for at least one client; and
based on the analyzing, determining that at least one deployment event of at least one project should be delayed for the at least one client.
